(19) United States
(12) Patent Application Publication
(10) Pub. No.: US 2024/0237099 A1
(43) Pub. Date: Jul. 11, 2024

(54) AUTOMATIC SIDELINK RESOURCE GRANT

(71) Applicant: QUALCOMM Incorporated, San Diego, CA (US)

(72) Inventors: Ahmed Attia ABOTABL, San Diego, CA (US); Seyedkianoush HOSSEINI, San Diego, CA (US); Marwen ZORGUI, San Diego, CA (US); Ahmed ELSHAFIE, San Diego, CA (US)

(21) Appl. No.: 18/151,853

(22) Filed: Jan. 9, 2023

(51) Int. Cl. H04W 76/15; H04L 5/00; H04W 76/14

(52) U.S. Cl. CPC H04W 76/15; H04L 5/0055; H04W 76/14

(57) ABSTRACT

Various aspects of the present disclosure generally relate to wireless communication. In some aspects, a first user equipment (UE) may receive downlink control information (DCI) from a network entity, wherein the DCI indicates multiple sidelink resources including a first sidelink resource and a second sidelink resource, wherein the first sidelink resource is for transmission of a sidelink communication to a second UE and wherein the second sidelink resource is for retransmission of the sidelink communication after a negative acknowledgment (NACK) of the sidelink communication on the first sidelink resource. The UE may transmit the sidelink communication to the second UE on at least one of the multiple sidelink resources. Numerous other aspects are described.

### FIELD OF THE DISCLOSURE

Aspects of the present disclosure generally relate to wireless communication and to techniques and apparatuses for automatic sidelink resource grants.

### BACKGROUND

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and types of wireless communications mediums available for use, and the like. Consequently, there exists a need for further improvements in wireless communications systems to overcome the aforementioned technical challenges and others.

### SUMMARY

Some aspects described herein relate to a method of wireless communication performed by a first user equipment (UE). The method may include receiving downlink control information (DCI) from a network entity, wherein the DCI indicates multiple sidelink resources including a first sidelink resource and a second sidelink resource, wherein the first sidelink resource is for transmission of a sidelink communication to a second UE and wherein the second sidelink resource is for retransmission of the sidelink communication after a negative acknowledgment (NACK) of the sidelink communication on the first sidelink resource. The method may include transmitting the sidelink communication to the second UE on at least one of the multiple sidelink resources.

Some aspects described herein relate to a method of wireless communication performed by a network entity. The method may include receiving a sidelink grant request between a first UE and a second UE. The method may include outputting or configuring DCI for the first UE, wherein the DCI indicates multiple sidelink resources including a first sidelink resource and a second sidelink resource, wherein the first sidelink resource is for transmission of a sidelink communication from the first UE to the second UE, and wherein the second sidelink resource is for retransmission of the sidelink communication after a NACK of the sidelink communication on the first sidelink resource.

Some aspects described herein relate to a user equipment configured for wireless communications. The user equipment configured may include a memory and one or more processors coupled to the memory.

Some aspects described herein relate to a network entity configured for wireless communications. The network entity configured may include a memory and one or more processors coupled to the memory.

Other aspects provide: an apparatus operable, configured, or otherwise adapted to perform any one or more of the aforementioned methods and/or those described herein with reference to and as illustrated by the drawings and specification; a non-transitory, computer-readable media comprising instructions that, when executed by a processor of an apparatus, cause the apparatus to perform the aforementioned methods as well as those described herein with reference to and as illustrated by the drawings and specification; a computer program product embodied on a computer-readable storage medium comprising code for performing the aforementioned methods as well as those described herein with reference to and as illustrated by the drawings and specification; and/or an apparatus comprising means for performing the aforementioned methods. as well as those described herein with reference to and as illustrated by the drawings and specification. By way of example, an apparatus may comprise a processing system, a device with a processing system, or processing systems cooperating over one or more networks.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 depicts an example of a wireless network, in accordance with the present disclosure.

FIG. 2 depicts aspects of an example base station and user equipment (UE), in accordance with the present disclosure.

FIG. 3 depicts an example disaggregated base station architecture.

FIGS. 4A, 4B, 4C, and 4D depict aspects of data structures for a wireless communications network, such as wireless network of FIG. 1, in accordance with the present disclosure.

FIG. 5 is a diagram illustrating an example of sidelink communications, in accordance with the present disclosure.

FIG. 6 is a diagram illustrating an example of sidelink communications and access link communications, in accordance with the present disclosure.

FIG. 7 is a diagram illustrating an example associated with automatic sidelink resource grants, in accordance with the present disclosure.

FIG. 8 shows a method for wireless communications by a UE, in accordance with the present disclosure.

FIG. 9 shows a method for wireless communications by a network entity, in accordance with the present disclosure.

FIG. 10 depicts aspects of an example communications device, in accordance with the present disclosure.

FIG. 11 depicts aspects of another example communications device, in accordance with the present disclosure.

### DETAILED DESCRIPTION

Aspects of the present disclosure provide apparatuses, methods, processing systems, and computer-readable mediums for automatically granting sidelink resources.

Telecommunication networks, such as cellular networks, consume energy. Reducing energy consumption is one way to make cellular networks more prevalent and accessible. Energy consumption increases when a network entity is unable to enter an energy-saving mode. For example, certain signals transmitted from a user equipment (UE) to the network entity may prevent the network entity from entering an energy-saving mode. Likewise, when the network entity operates in an energy-saving mode, certain network functionality becomes limited, even functionality like sidelink communications which generally require little of the network entity.

Reducing the occurrence of signals that require a response from the network entity, such as signals renewing sidelink resource grants following a failed sidelink communication, can allow the network entity to enter into an energy-saving mode more frequently, thereby resulting in less energy consumption. One way to reduce the occurrence of such signals is for the network entity to automatically grant additional resources following a failed sidelink communication. Moreover, the automatic grant of additional sidelink resources means UEs can engage in sidelink communications with less involvement from the network entity. Accordingly, the automatic granting of sidelink resources by the network entity following a failed sidelink communication can help reduce energy consumption without significantly impacting functionality related to sidelink communications.

Various aspects of the disclosure are described more fully hereinafter with reference to the accompanying drawings. This disclosure may however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

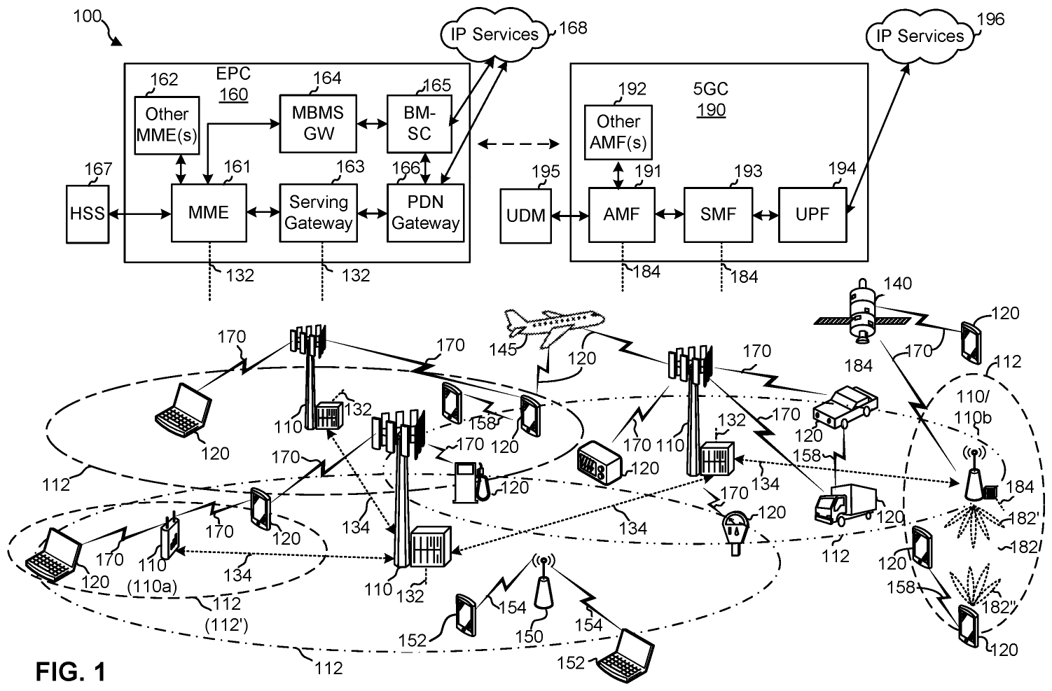

FIG. 1 depicts an example of a wireless network 100, in accordance with the present disclosure.

Generally, wireless network 100 includes various network entities (alternatively, network elements or network nodes). A network entity is generally a communications device and/or a communications function performed by a communications device (e.g., a user equipment (UE), a base station (BS), a component of a BS, a server, etc.). For example, various functions of a network as well as various devices associated with and interacting with a network may be considered network entities. Further, wireless network 100 includes terrestrial aspects, such as ground-based network entities (e.g., BSs 110), and non-terrestrial aspects, such as satellite 140 and aircraft 145, which may include network entities on-board (e.g., one or more BSs) capable of communicating with other network elements (e.g., terrestrial BSs) and UEs.

In the depicted example, wireless network 100 includes BSs 110, UEs 120, and one or more core networks, such as an Evolved Packet Core (EPC) 160 and a 5G Core (5GC) 190, which may interoperate to provide communications services over various communications links, including wired and wireless links.

FIG. 1 depicts various example UEs 120, which may include: a cellular phone, a smart phone, a session initiation protocol (SIP) phone, a laptop, a personal digital assistant (PDA), a satellite radio, a global positioning system unit, a multimedia device, a video device, a digital audio player, a camera, a game console, a tablet, a smart device, a wearable device, a vehicle, an electric meter, a gas pump, a kitchen appliance, a healthcare device, an implant, a sensor/actuator, a display, an internet of things (IoT) device, an always on (AON) device, an edge processing device, or another device. A UE 120 may also be referred to more generally as a mobile device, a wireless device, a wireless communications device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, or a handset, among other examples.

BSs 110 may wirelessly communicate with (e.g., transmit signals to or receive signals from) UEs 120 via communications links 170. The communications links 170 between BSs 110 and UEs 120 may carry uplink (UL) (also referred to as reverse link) transmissions from a UE 120 to a BS 110 and/or downlink (DL) (also referred to as forward link) transmissions from a BS 110 to a UE 120. The communications links 170 may use multiple-input and multiple-output (MIMO) antenna technology, including spatial multiplexing, beamforming, and/or transmit diversity in various aspects.

BSs 110 may generally include, for example, a NodeB, an enhanced NodeB (eNB), a next generation enhanced NodeB (ng-eNB), a next generation NodeB (gNB or gNodeB), an access point, a base transceiver station, a radio base station, a radio transceiver, a transceiver function, a transmission reception point, and/or others. A BS 110 may provide communications coverage for a respective geographic coverage area 112, which may sometimes be referred to as a cell, and which may overlap in some cases (e.g., a small cell provided by a BS 110a may have a coverage area 112′ that overlaps the coverage area 112 of a macro cell). A BS may for example, provide communications coverage for a macro cell (covering a relatively large geographic area), a pico cell (covering a relatively smaller geographic area, such as a sports stadium), a femto cell (covering a relatively smaller geographic area (e.g., a home)), and/or other types of cells.

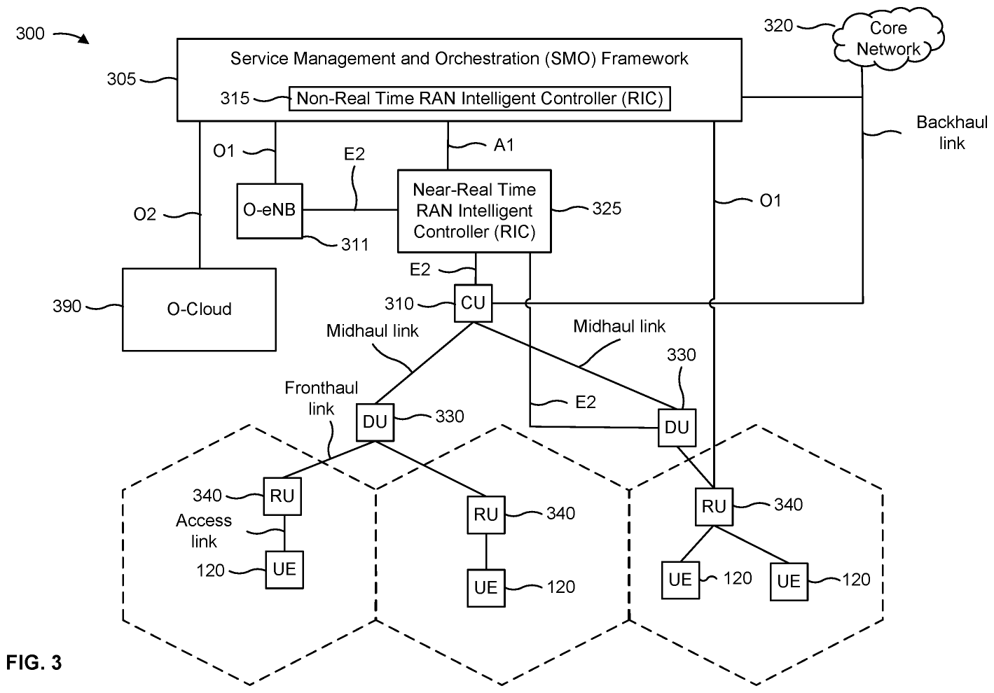

While BSs 110 are depicted in various aspects as unitary communications devices, BSs 110 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 110) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 3 depicts and describes an example disaggregated base station architecture.

Different BSs 110 within wireless network 100 may also be configured to support different radio access technologies, such as 3G, 4G, and/or 5G, among other examples. For example, BSs 110 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 110 configured for 5G (e.g., 5G NR or Next Generation RAN (NG-RAN)) may interface with 5GC 190 through second backhaul links 184. BSs 110 may communicate directly or indirectly (e.g., through the EPC 160 or 5GC 190) with each other over third backhaul links 134 (e.g., X2 interfaces), which may be wired or wireless.

Wireless network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 410 megahertz (MHz)-7125 MHz, which is often referred to (interchangeably) as “Sub-6 GHz”. Similarly, 3GPP currently defines Frequency Range 2 (FR2) as including 24,250 MHz-52,600 MHz, which is sometimes referred to (interchangeably) as a “millimeter wave” (“mmW” or “mmWave”). A base station configured to communicate using mmWave or near mmWave radio frequency bands (e.g., a mmWave base station such as BS 110b) may utilize beamforming (e.g., as shown by 182) with a UE (e.g., 120) to improve path loss and range.

The communications links 170 between BSs 110 and, for example, UEs 120, may use one or more carriers, which may have different bandwidths (e.g., 5 MHz, 10 MHz, 15 MHz, 20 MHz, 100 MHz, 400 MHz, and/or other bandwidths), and which may be aggregated in various aspects. Carriers may or may not be adjacent to each other in frequency. In some examples, allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., base station 110b in FIG. 1) may utilize beamforming with a UE 120 to improve path loss and range, as shown at 182. For example, BS 110b and the UE 120 may each include a plurality of antennas, such as antenna elements, antenna panels, and/or antenna arrays to facilitate the beamforming. In some cases, BS 110b may transmit a beamformed signal to UE 120 in one or more transmit directions 182′. UE 120 may receive the beamformed signal from the BS 110b in one or more receive directions 182′′. UE 120 may also transmit a beamformed signal to the BS 110b in one or more transmit directions 182′′. BS 110b may also receive the beamformed signal from UE 120 in one or more receive directions 182′. BS 110b and UE 120 may then perform beam training to determine the best receive and transmit directions for each of BS 110b and UE 120. Notably, the transmit and receive directions for BS 110b may or may not be the same. Similarly, the transmit and receive directions for UE 120 may or may not be the same.

Wireless network 100 may include a Wi-Fi AP 150 in communication with Wi-Fi stations (STAs) 152 (e.g., UEs 120) via communications links 154 in, for example, a 2.4 GHz and/or 5 GHz unlicensed frequency spectrum.

Certain UEs 120 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility

Management Entity (MME) 161, other MMEs 162, a Serving Gateway 163, a Multimedia Broadcast Multicast Service (MBMS) Gateway 164, a Broadcast Multicast Service Center (BM-SC) 165, and/or a Packet Data Network (PDN) Gateway 166, such as in the depicted example. MME 161 may be in communication with a Home Subscriber Server (HSS) 167. MME 161 is the control node that processes the signaling between the UEs 120 and the EPC 160. Generally, MME 161 provides bearer and connection management.

User Internet protocol (IP) packets may be transferred through Serving Gateway 163, which is connected to PDN Gateway 166. PDN Gateway 166 provides UE IP address allocation as well as other functions. PDN Gateway 166 and the BM-SC 165 are connected to IP Services 168, which may include, for example, the Internet, an intranet, an IP Multimedia Subsystem (IMS), a Packet Switched (PS) streaming service, and/or other IP services.

BM-SC 165 may provide functions for MBMS user service provisioning and delivery. BM-SC 165 may serve as an entry point for content provider MBMS transmission, may be used to authorize and initiate MBMS Bearer Services within a public land mobile network (PLMN), and/or may be used to schedule MBMS transmissions. MBMS Gateway 164 may be used to distribute MBMS traffic to the BSs 110 belonging to a Multicast Broadcast Single Frequency Network (MBSFN) area broadcasting a particular service, and/or may be responsible for session management (e.g., session start/stop) and for collecting eMBMS related charging information.

5GC 190 may include various functional components, including: an Access and Mobility Management Function (AMF) 191, other AMFs 192, a Session Management Function (SMF) 193, and a User Plane Function (UPF) 194. AMF 191 may be in communication with Unified Data Management (UDM) 195.

AMF 191 is a control node that processes signaling between UEs 120 and 5GC 190. AMF 191 provides, for example, quality of service (QoS) flow and session management.

IP packets are transferred through UPF 194, which is connected to the IP Services 196, and which provides UE IP address allocation as well as other functions for 5GC 190. IP Services 196 may include, for example, the Internet, an intranet, an IMS, a PS streaming service, and/or other IP services.

In various aspects, a network entity or network node can be implemented as an aggregated base station, a disaggregated base station, a component of a base station, an integrated access and backhaul (IAB) node, a relay node, a sidelink node, or a transmission reception point (TRP), to name a few examples.

As indicated above, FIG. 1 is provided as an example. Other examples may differ from what is described with regard to FIG. 1.

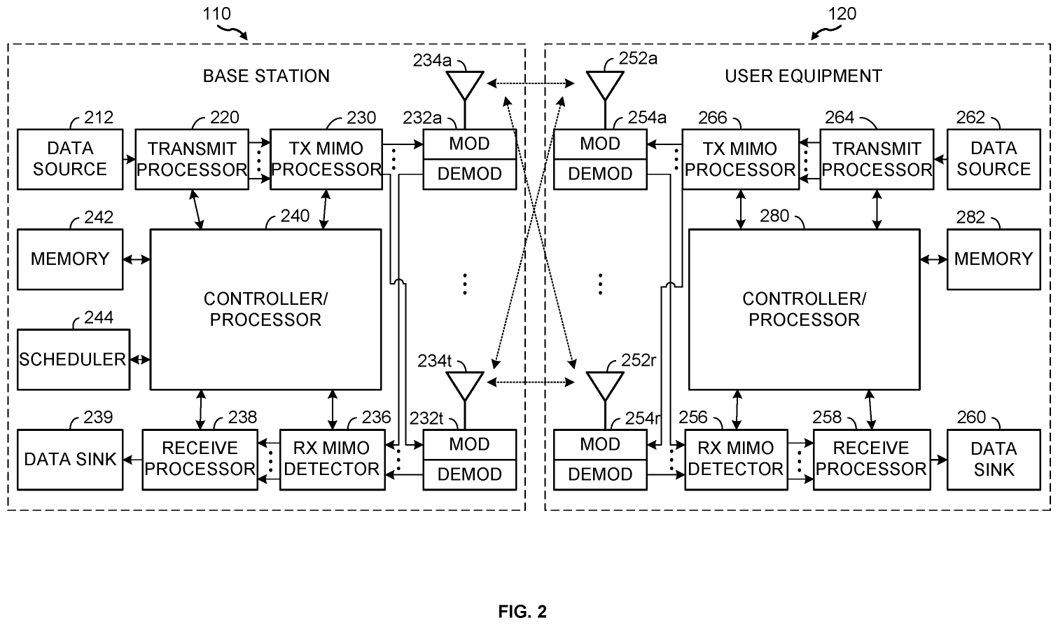

FIG. 2 depicts aspects of an example BS 110 and UE 120, in accordance with the present disclosure.

BS 110 includes various processors (e.g., 220, 230, 238, and 240), antennas 234a-t (collectively 234), transceivers 232a-t (collectively 232), which include modulators and demodulators, and other aspects, which enable wireless transmission of data (e.g., data source 212) and wireless reception of data (e.g., data sink 239). For example, BS 110 may send and receive data between BS 110 and UE 120. BS 110 includes controller/processor 240, which may be configured to implement various functions described herein related to wireless communications.

UE 120 includes various processors (e.g., 258, 264, 266, and 280), antennas 252a-r (collectively 252), transceivers 254a-r (collectively 254), which include modulators and demodulators, and other aspects, which enable wireless transmission of data (e.g., retrieved from data source 262) and wireless reception of data (e.g., provided to data sink 260). UE 120 includes controller/processor 280, which may be configured to implement various functions described herein related to wireless communications.

For an example downlink transmission, BS 110 includes a transmit processor 220 that may receive data from a data source 212 and control information from a controller/processor 240. The control information may be for the physical broadcast channel (PBCH), physical control format indicator channel (PCFICH), physical hybrid automatic repeat request (HARQ) indicator channel (PHICH), physical downlink control channel (PDCCH), group common PDCCH (GC PDCCH), and/or others. The data may be for the physical downlink shared channel (PDSCH), in some examples.

Transmit processor 220 may process (e.g., encode and symbol map) the data and control information to obtain data symbols and control symbols, respectively. Transmit processor 220 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 230 may perform spatial processing (e.g., precoding) on the data symbols, the control symbols, and/or the reference symbols, if applicable, and may provide output symbol streams to the modulators (MODs) in transceivers 232a-232t. Each modulator in transceivers 232a-232t may process a respective output symbol stream to obtain an output sample stream. Each modulator may further process (e.g., convert to analog, amplify, filter, and upconvert) the output sample stream to obtain a downlink signal. Downlink signals from the modulators in transceivers 232a-232t may be transmitted via the antennas 234a-234t, respectively.

In order to receive the downlink transmission, UE 120 includes antennas 252a-252r that may receive the downlink signals from the BS 110 and may provide received signals to the demodulators (DEMODs) in transceivers 254a-254r, respectively. Each demodulator in transceivers 254a-254r may condition (e.g., filter, amplify, downconvert, and digitize) a respective received signal to obtain input samples. Each demodulator may further process the input samples to obtain received symbols.

MIMO detector 256 may obtain received symbols from all the demodulators in transceivers 254a-254r, perform MIMO detection on the received symbols if applicable, and provide detected symbols. Receive processor 258 may process (e.g., demodulate, deinterleave, and decode) the detected symbols, provide decoded data for the UE 120 to a data sink 260, and provide decoded control information to a controller/processor 280.

For an example uplink transmission, UE 120 further includes a transmit processor 264 that may receive and process data (e.g., for the physical uplink shared channel (PUSCH)) from a data source 262 and control information (e.g., for the physical uplink control channel (PUCCH)) from the controller/processor 280. Transmit processor 264 may also generate reference symbols for a reference signal (e.g., for the sounding reference signal (SRS)). The symbols from the transmit processor 264 may be precoded by a TX MIMO processor 266 if applicable, further processed by the modulators in transceivers 254a-254r (e.g., for SC-FDM), and transmitted to BS 110.

At BS 110, the uplink signals from UE 120 may be received by antennas 234a-t, processed by the demodulators in transceivers 232a-232t, detected by a MIMO detector 236 if applicable, and further processed by a receive processor 238 to obtain decoded data and control information sent by UE 120. Receive processor 238 may provide the decoded data to a data sink 239 and the decoded control information to the controller/processor 240. Memories 242 and 282 may store data and program codes for BS 110 and UE 120, respectively. Scheduler 244 may schedule UEs for data transmission on the downlink and/or uplink.

In various aspects, BS 110 may be described as transmitting and receiving various types of data associated with the methods described herein. In these contexts, “transmitting” may refer to various mechanisms of outputting data, such as outputting data from data source 212, scheduler 244, memory 242, transmit processor 220, controller/processor 240, TX MIMO processor 230, transceivers 232a-t, antenna 234a-t, and/or other aspects described herein. Similarly, “receiving” may refer to various mechanisms of obtaining data, such as obtaining data from antennas 234a-t, transceivers 232a-t, RX MIMO detector 236, controller/processor 240, receive processor 238, scheduler 244, memory 242, and/or other aspects described herein.

In various aspects, UE 120 may likewise be described as transmitting and receiving various types of data associated with the methods described herein. In these contexts, “transmitting” may refer to various mechanisms of outputting data, such as outputting data from data source 262, memory 282, transmit processor 264, controller/processor 280, TX MIMO processor 266, transceivers 254a-t, antenna 252a-t, and/or other aspects described herein. Similarly, “receiving” may refer to various mechanisms of obtaining data, such as obtaining data from antennas 252a-t, transceivers 254a-t, RX MIMO detector 256, controller/processor 280, receive processor 258, memory 282, and/or other aspects described herein.

In some aspects, a processor may be configured to perform various operations, such as those associated with the methods described herein, and transmit (output) to or receive (obtain) data from another interface that is configured to transmit or receive, respectively, the data.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an eNB, an NR BS, a 5G NB, an AP, a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network entity) may be configured to utilize a radio protocol stack that is physically or logically integrated within a single RAN node (e.g., within a single device or unit). A disaggregated base station (e.g., a disaggregated network entity) may be configured to utilize a protocol stack that is physically or logically distributed among two or more units (such as one or more CUs, one or more DUs, or one or more RUs). In some examples, a CU may be implemented within a network entity, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

FIG. 3 depicts an example disaggregated base station 300 architecture. The disaggregated base station 300 architecture may include one or more CUs 310 that can communicate directly with a core network 320 via a backhaul link, or indirectly with the core network 320 through one or more disaggregated base station units (such as a Near-Real Time (Near-RT) RAN Intelligent Controller (RIC) 325 via an E2 link, or a Non-Real Time (Non-RT) RIC 315 associated with a Service Management and Orchestration (SMO) Framework 305, or both). A CU 310 may communicate with one or more DUs 330 via respective midhaul links, such as an F1 interface. The DUs 330 may communicate with one or more RUs 340 via respective fronthaul links. The RUs 340 may communicate with respective UEs 120 via one or more RF access links. In some implementations, the UE 120 may be simultaneously served by multiple RUs 340.

Each of the units (e.g., the CUs 310, the DUs 330, the RUs 340, as well as the Near-RT RICs 325, the Non-RT RICs 315 and the SMO Framework 305) may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (e.g., Central Unit-User Plane (CU-UP)), control plane functionality (e.g., Central Unit-Control Plane (CU-CP)), or a combination thereof. In some implementations, the CU 310 can be logically split into one or more CU-UP units and one or more CU-CP units. The CU-UP unit can communicate bidirectionally with the CU-CP unit via an interface, such as the E1 interface when implemented in an O-RAN configuration. The CU 310 can be implemented to communicate with the distributed unit (DU) 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 330 may further host one or more low PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 can be implemented to handle over-the-air (OTA) communications with one or more UEs 120. In some implementations, real-time and non-real-time aspects of control and user plane communications with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (such as an O1 interface). For virtualized network elements, the SMO Framework 305 may be configured to interact with a cloud computing platform (such as an open cloud (O-Cloud) 390) to perform network element life cycle management (such as to instantiate virtualized network elements) via a cloud computing platform interface (such as an O2 interface). Such virtualized network elements can include, but are not limited to, CUs 310, DUs 330, RUs 340, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, artificial intelligence/machine learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via O1) or via creation of RAN management policies (such as A1 policies).

As indicated above, FIG. 3 is provided as an example. Other examples may differ from what is described with regard to FIG. 3.

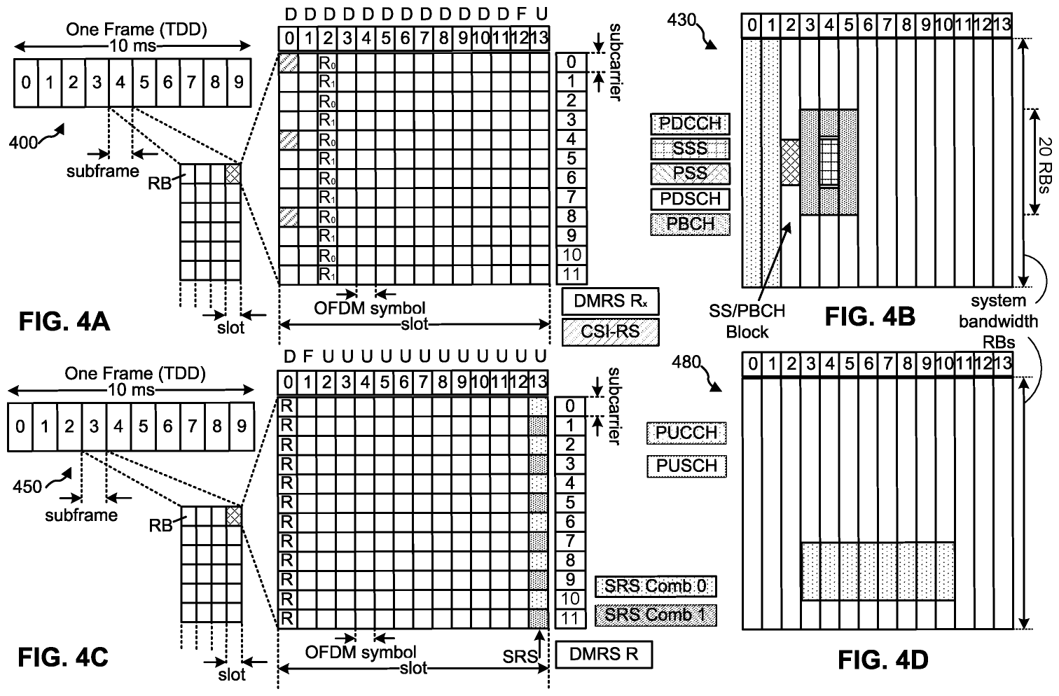

FIGS. 4A, 4B, 4C, and 4D depict aspects of data structures for a wireless communications network, such as wireless network 100 of FIG. 1, in accordance with the present disclosure. FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where D is DL, U is UL, and F is flexible for use between DL/UL. UEs may be configured with a slot format through a received slot format indicator (SFI) (dynamically through DL control information (DCI), or semi-statically/statically through RRC signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (μ) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2 μ slots/subframe. The subcarrier spacing and symbol length/duration are a function of the numerology. The subcarrier spacing may be equal to 2 μ×15 kHz, where μ is the numerology index, which may be selected from values 0 to 5. Accordingly, the numerology μ=0 has a subcarrier spacing of 15 kHz and the numerology μ=5 has a subcarrier spacing of 480 kHz. Other numerologies and subcarrier spacings may be used. The symbol length/duration is inversely related to the subcarrier spacing. FIGS. 4A, 4B, 4C, and 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RSs) for a UE (e.g., UE 120). The RSs may include demodulation RSs (DMRSs) and/or channel state information reference signals (CSI-RSs) for channel estimation at the UE. The RSs may also include beam measurement RSs (BRSs), beam refinement RSs (BRRSs), and/or phase tracking RSs (PT-RSs).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., UE 120) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the

UE can determine the locations of the aforementioned DMRSs. The physical broadcast channel (PBCH), which carries a master information block (MIB), may be logically grouped with the PSS and SSS to form a synchronization signal (SS)/PBCH block (SSB). The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRSs (indicated as R for one particular configuration, but other DMRS configurations are possible) for channel estimation at the base station. The UE may transmit DMRSs for the PUCCH and DMRSs for the PUSCH. The PUSCH DMRSs may be transmitted, for example, in the first one or two symbols of the PUSCH. The PUCCH DMRSs may be transmitted in different configurations depending on whether short or long PUCCHs are transmitted and depending on the particular PUCCH format used. UE 120 may transmit sounding reference signals (SRSs). The SRSs may be transmitted, for example, in the last symbol of a subframe. The SRSs may have a comb structure, and a UE may transmit SRSs on one of the combs. The SRSs may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

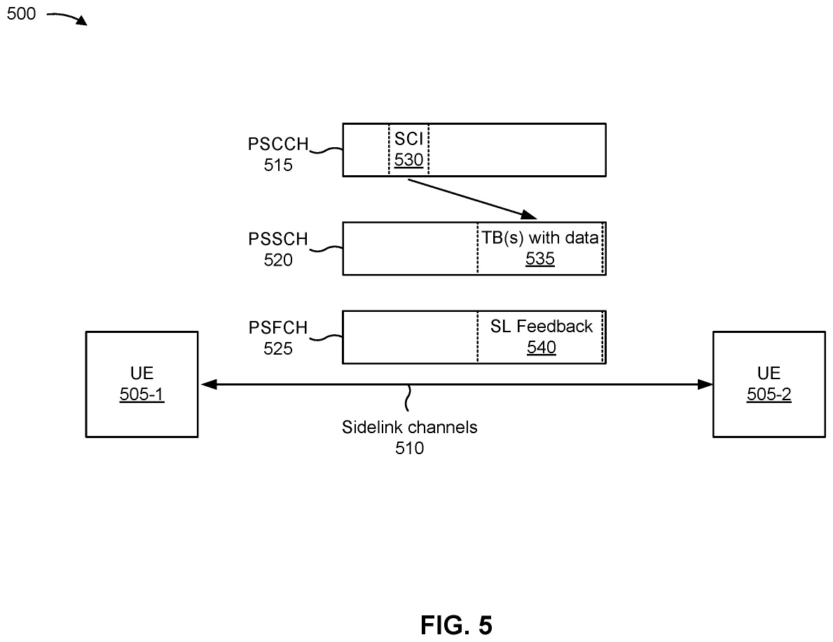

FIG. 5 is a diagram illustrating an example 500 of sidelink communications, in accordance with the present disclosure.

As shown in FIG. 5, a first UE 505-1 may communicate with a second UE 505-2 (and one or more other UEs 505) via one or more sidelink channels 510. The UEs 505-1 and 505-2 may communicate using the one or more sidelink channels 510 for point-to-point (P2P) communications, device-to-device (D2D) communications, vehicle-to-anything (V2X) communications (e.g., which may include vehicle-to-vehicle (V2V) communications, vehicle-to-infrastructure (V2I) communications, and/or vehicle-to-pedestrian (V2P) communications) and/or mesh networking. In some aspects, the UEs 505 (e.g., UE 505-1 and/or UE 505-2) may correspond to one or more other UEs described elsewhere herein, such as UE 120. In some aspects, the one or more sidelink channels 510 may use a PC5 interface and/or may operate in a high frequency band (e.g., the 5.9 GHz band). Additionally, or alternatively, the UEs 505 may synchronize timing of transmission time intervals (TTIs) (e.g., frames, subframes, slots, or symbols) using global navigation satellite system (GNSS) timing.

As further shown in FIG. 5, the one or more sidelink channels 510 may include a physical sidelink control channel (PSCCH) 515, a physical sidelink shared channel (PSSCH) 520, and/or a physical sidelink feedback channel (PSFCH) 525. The PSCCH 515 may be used to communicate control information, similar to a physical downlink control channel (PDCCH) and/or a physical uplink control channel (PUCCH) used for cellular communications with a network node 110 via an access link or an access channel. The PSSCH 520 may be used to communicate data, similar to a physical downlink shared channel (PDSCH) and/or a physical uplink shared channel (PUSCH) used for cellular communications with a network node 110 via an access link or an access channel. For example, the PSCCH 515 may carry sidelink control information (SCI) 530, which may indicate various control information used for sidelink communications, such as one or more resources (e.g., time resources, frequency resources, and/or spatial resources) where a transport block (TB) 535 may be carried on the PSSCH 520. The TB 535 may include data. The PSFCH 525 may be used to communicate sidelink feedback 540, such as hybrid automatic repeat request (HARQ) feedback (e.g., acknowledgement or negative acknowledgement (ACK/NACK) information), transmit power control (TPC), and/or a scheduling request (SR).

Although shown on the PSCCH 515, in some aspects, the SCI 530 may include multiple communications in different stages, such as a first stage SCI (SCI-1) and a second stage SCI (SCI-2). The SCI-1 may be transmitted on the PSCCH 515. The SCI-2 may be transmitted on the PSSCH 520. The SCI-1 may include, for example, an indication of one or more resources (e.g., time resources, frequency resources, and/or spatial resources) on the PSSCH 520, information for decoding sidelink communications on the PSSCH, a quality of service (QoS) priority value, a resource reservation period, a PSSCH demodulation reference signal (DMRS) pattern, an SCI format for the SCI-2, a beta offset for the SCI-2, a quantity of PSSCH DMRS ports, and/or a modulation and coding scheme (MCS). The SCI-2 may include information associated with data transmissions on the PSSCH 520, such as a hybrid automatic repeat request (HARQ) process ID, a new data indicator (NDI), a source identifier, a destination identifier, and/or a channel state information (CSI) report trigger.

In some aspects, the one or more sidelink channels 510 may use resource pools. For example, a scheduling assignment (e.g., included in SCI 530) may be transmitted in sub-channels using specific resource blocks (RBs) across time. In some aspects, data transmissions (e.g., on the PSSCH 520) associated with a scheduling assignment may occupy adjacent RBs in the same subframe as the scheduling assignment (e.g., using frequency division multiplexing). In some aspects, a scheduling assignment and associated data transmissions are not transmitted on adjacent RBs.

In some aspects, a UE 505 may operate using a sidelink transmission mode (e.g., Mode 1) where resource selection and/or scheduling is performed by a network node 110 (e.g., a base station, a CU, or a DU). For example, the UE 505 may receive a grant (e.g., in downlink control information (DCI) or in a radio resource control (RRC) message, such as for configured grants) from the network node 110 (e.g., directly or via one or more network nodes) for sidelink channel access and/or scheduling. In some aspects, a UE 505 may operate using a transmission mode (e.g., Mode 2) where resource selection and/or scheduling is performed by the UE 505 (e.g., rather than a network node 110). In some aspects, the UE 505 may perform resource selection and/or scheduling by sensing channel availability for transmissions. For example, the UE 505 may measure a received signal strength indicator (RSSI) parameter (e.g., a sidelink-RSSI (S-RSSI) parameter) associated with various sidelink channels, may measure a reference signal received power (RSRP) parameter (e.g., a PSSCH-RSRP parameter) associated with various sidelink channels, and/or may measure a reference signal received quality (RSRQ) parameter (e.g., a PSSCH-RSRQ parameter) associated with various sidelink channels, and may select a channel for transmission of a sidelink communication based at least in part on the measurement(s).

Additionally, or alternatively, the UE 505 may perform resource selection and/or scheduling using SCI 530 received in the PSCCH 515, which may indicate occupied resources and/or channel parameters. Additionally, or alternatively, the UE 505 may perform resource selection and/or scheduling by determining a channel busy ratio (CBR) associated with various sidelink channels, which may be used for rate control (e.g., by indicating a maximum number of resource blocks that the UE 505 can use for a particular set of subframes).

In the transmission mode where resource selection and/or scheduling is performed by a UE 505, the UE 505 may generate sidelink grants, and may transmit the grants in SCI 530. A sidelink grant may indicate, for example, one or more parameters (e.g., transmission parameters) to be used for an upcoming sidelink transmission, such as one or more resource blocks to be used for the upcoming sidelink transmission on the PSSCH 520 (e.g., for TBs 535), one or more subframes to be used for the upcoming sidelink transmission, and/or a modulation and coding scheme (MCS) to be used for the upcoming sidelink transmission. In some aspects, a UE 505 may generate a sidelink grant that indicates one or more parameters for semi-persistent scheduling (SPS), such as a periodicity of a sidelink transmission. Additionally, or alternatively, the UE 505 may generate a sidelink grant for event-driven scheduling, such as for an on-demand sidelink message.

As indicated above, FIG. 5 is provided as an example. Other examples may differ from what is described with respect to FIG. 5.

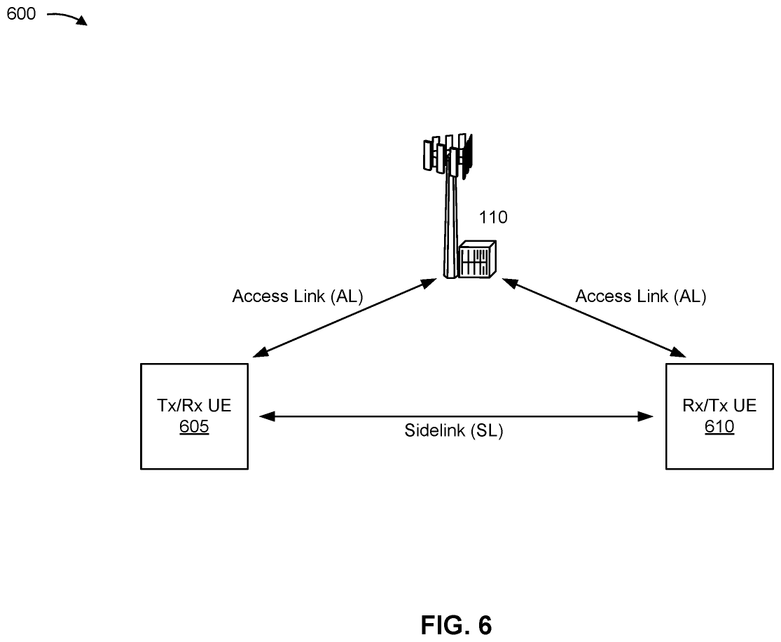

FIG. 6 is a diagram illustrating an example 600 of sidelink communications and access link communications, in accordance with the present disclosure.

As shown in FIG. 6, a transmitter (Tx)/receiver (Rx) UE 605 and an Rx/Tx UE 610 may communicate with one another via a sidelink, as described above in connection with FIG. 5. As further shown, in some sidelink modes, a network node 110 may communicate with the Tx/Rx UE 605 (e.g., directly or via one or more network nodes), such as via a first access link. Additionally, or alternatively, in some sidelink modes, the network node 110 may communicate with the Rx/Tx UE 610 (e.g., directly or via one or more network nodes), such as via a first access link. The Tx/Rx UE 605 and/or the Rx/Tx UE 610 may correspond to one or more UEs described elsewhere herein, such as the UE 120 of FIG. 1. Thus, a direct link between UEs 120 (e.g., via a PC5 interface) may be referred to as a sidelink, and a direct link between a network 110 and a UE 120 (e.g., via a Uu interface) may be referred to as an access link. Sidelink communications may be transmitted via the sidelink, and access link communications may be transmitted via the access link. An access link communication may be either a downlink communication (from a network node 110 to a UE 120) or an uplink communication (from a UE 120 to a network node 110).

As indicated above, FIG. 6 is provided as an example. Other examples may differ from what is described with respect to FIG. 6.

Energy consumption increases when a network entity is unable to enter an energy-saving mode. For example, certain signals transmitted from a UE to the network entity may prevent the network entity from entering an energy-saving mode. Likewise, when the network entity operates in an energy-saving mode, certain network functionality becomes limited, even functionality like sidelink communications which generally require little of the network entity.

Some techniques described herein include the UE receiving DCI from a network entity, wherein the DCI allocates multiple sidelink resources including a first sidelink resource and a second sidelink resource, wherein the first sidelink resource is for transmission of a sidelink communication to a UE and wherein the second sidelink resource is for retransmission of the sidelink communication after a NACK of the sidelink communication on the first sidelink resource; and transmitting the sidelink communication to the UE on at least one of the multiple sidelink resources. With the allocation of multiple sidelink resources, the UE may retransmit failed sidelink communications without interfering with the network entity operating in a sleep mode.

Some techniques described herein include a network entity receiving, from a first UE, a sidelink grant request between the first UE and a second UE; and outputting or configuring DCI to the first UE, wherein the DCI allocates multiple sidelink resources including a first sidelink resource and a second sidelink resource, wherein the first sidelink resource is for transmission of a sidelink communication from the first UE to the second UE and wherein the second sidelink resource is for retransmission of the sidelink communication after a NACK of the sidelink communication on the first sidelink resource. The automatic granting of sidelink resources by the network entity following a failed sidelink communication can help reduce energy consumption without significantly impacting functionality related to sidelink communications.

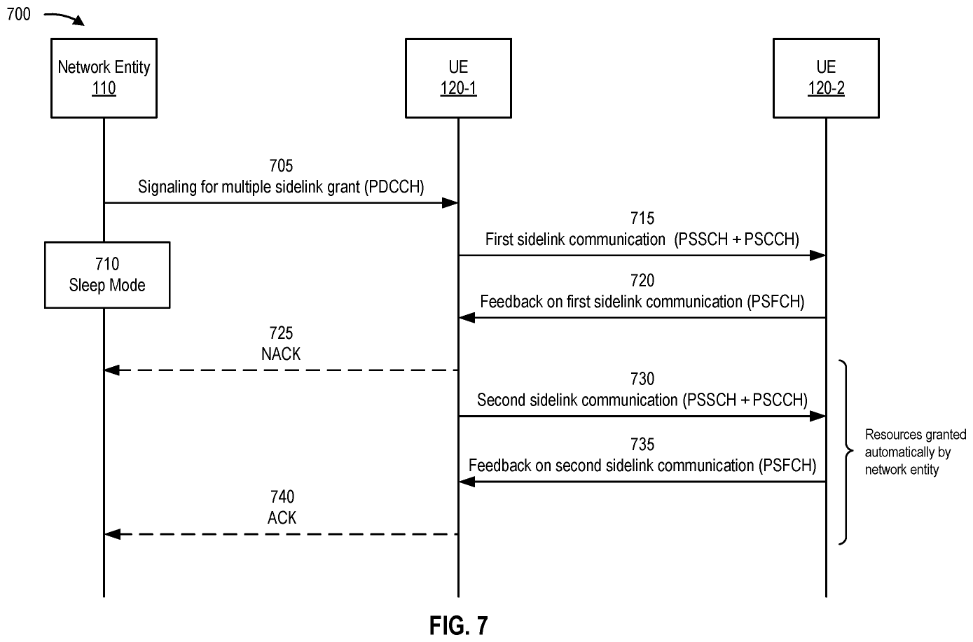

FIG. 7 is a diagram illustrating an example 700 associated with automatic sidelink resource grants, in accordance with the present disclosure. As shown in FIG. 7, a network entity (such as base station 110) and a UE (such as UE 120) may communicate with one another via a Uu interface. Moreover, as shown in FIG. 7, two UEs (shown as 120-1 and 120-2 in FIG. 7) may communicate with one another via a sidelink interface such as a PC5 interface. For purposes of FIG. 7, the UE 120-1 may be referred to as a “first UE” and the UE 120-2 may be referred to as a “second UE.”

As shown by reference number 705, the network entity transmits, and the UE receives, signaling authorizing multiple sidelink resources. The signaling, which may include DCI or RRC signaling, may be transmitted on the PDCCH. In one aspect, the signaling may grant resources for sidelink transmissions on the PSSCH and PSCCH, feedback on the PSFCH, and retransmission of one or more failed communications. With reference to example 700, the multiple sidelink resources may include a first sidelink resource for a sidelink communication. Additional sidelink resources, including a second sidelink resource, may be automatically granted for retransmission of the sidelink communication if the initial transmission of the sidelink communication failed. In some aspects, the term “automatically” refers to the granting of resources for the second sidelink communication without additional signaling from the network entity. In some aspects, the automatic granting of additional sidelink resources may occur while the network entity is operating in a sleep mode, as discussed in greater detail below.

As shown by reference number 710, the network entity may enter a sleep mode after transmitting the DCI and/or RRC signaling. When operating in the sleep mode, certain functions, components, and/or a combination thereof, of the network entity may be temporarily deactivated to, e.g., reduce energy consumption. Examples of functions and/or components temporarily deactivated during the sleep mode may include functions and/or components associated with the transmission and/or reception of communications with UEs, other network entities, and/or a combination thereof. Because the signaling at reference number 705 provides for automatic resource grants for retransmission of failed sidelink communications, the network entity may enter the sleep mode while still permitting sidelink communications between the UEs.

As shown by reference number 715, the first UE may transmit, and the second UE may receive, a first sidelink communication on the PSSCH and PSCCH. Resources for the first sidelink communication may have been granted by the DCI or RRC signaling at 705.

As shown by reference number 720, the second UE may transmit, and the first UE may receive, feedback on the PSFCH. The feedback may include NACK indicating that the first sidelink communication was not successfully received, decoded, verified, and/or a combination thereof, by the second UE. In some aspects, the second UE need not transmit NACK to the first UE. In such cases, the first UE may assume NACK if no feedback is received.

As shown by reference number 725, the first UE may transmit the NACK to the network entity. In instances where the network entity has entered the sleep mode, the network entity may not receive the NACK. Thus, the first UE may not forward NACK to the network entity in instances where the network entity has entered the sleep mode. In some aspects, the first UE may transmit NACK to the network entity in instances where NACK is received at reference number 720. In some aspects, the first UE may transmit NACK to the network entity in instances where NACK is assumed at reference number 720.

As shown by reference number 730, the first UE may transmit, and the second UE may receive, a second sidelink communication on the PSSCH and PSCCH. Resources for the second sidelink communication were automatically granted by the DCI at 705, which as discussed above was transmitted, by the network entity, to the first UE prior to the network entity entering the sleep mode.

In some aspects, the second resource may occur a predetermined number of slots after the first resource. The predetermined number of slots may be indicated by the DCI or RRC signaling. In some instances, the predetermined number of slots may be based on the number of retransmission attempts. For example, the DCI or RRC signaling may allocate an increasing number of slots between retransmission attempts (e.g., 3 slots after the first attempt, 5 slots after the second attempt, etc.). The number of slots may be counted from either the time of the reception of the sidelink feedback or the NACK retransmission to the network entity. The number of slots as a function of transmission attempts may be an RRC configured parameter. Modifying the number of slots between transmission attempts may introduce variations that increase diversity in the transmission, increasing the likelihood that a subsequent transmission will succeed.

In some aspects, a time and/or frequency characteristic of the second resource may be different from a time and/or frequency characteristic of the first resource. The different time and/or frequency characteristics for retransmissions may be indicated by the DCI and/or RRC signaling. In some aspects, the same resources and configurations indicated in the grant DCI may be applied to retransmissions. In some aspects, the same resources as indicated in the grant DCI may be applied but with different configurations based on, e.g., RRC signaling. In some aspects, both the resources and configurations may be modified from those indicated in the DCI grant via, e.g., RRC signaling. In some aspects, time and/or frequency resources may be shifted every time a sidelink communication fails to, e.g., avoid a channel with low capacity. In some aspects, the time and/or frequency resources may be scaled every time a sidelink communication fails. Scaling the time and/or frequency resources may reduce interference and/or give the UEs more time to receive, decode, and/or verify sidelink communications.

In some aspects, the UEs may be configured with a maximum number of automatically granted sidelink attempts. If the sidelink communication between the first UE and the second UE fails, the first UE may assume a predetermined number of retransmission grants (e.g., the first UE may assume resources are available to retransmit the sidelink communication without requesting additional resources from the network entity). In some aspects, the first UE may continue retransmission attempts of failed sidelink communications until the maximum number of automatically granted sidelink attempts has been reached. In some aspects, after the maximum number of automatically granted sidelink attempts has been reached, the first UE may not assume the availability of the granted resources. In such cases, a new grant of resources may be needed for subsequent sidelink communications between the first UE and the second UE. In some aspects, the maximum number of automatically granted sidelink attempts may be an RRC configured parameter.

Automatically increasing the number of slots and/or automatically adjusting the time and/or frequency characteristics between retransmission attempts may proactively address certain reasons the transmission may have failed. For example, if the second UE did not have sufficient time to receive, decode, and verify the communication, or if there was interference during previous communications, automatically increasing the number of slots, changing the time and/or frequency characteristics, a combination thereof, and/or the like, may increase the likelihood retransmission attempts will be successful.

As shown by reference number 735, the second UE transmits, and the first UE receives, feedback on the second sidelink communication. The feedback may be received on the PSFCH. In the case of successfully received, decoded, and/or verified communications, the feedback may include ACK.

As shown by reference number 740, the first UE may transmit the ACK to the network entity. The first UE may transmit the ACK to indicate, to the network entity, that the sidelink communication was successful. In instances where the network entity is operating in a sleep mode, the network entity may not receive the ACK. Alternatively, in instances where the network entity is operating in the sleep mode, the network entity may ignore the ACK.

Accordingly, the network entity may automatically grant sidelink resources to, e.g., help reduce energy consumption without significantly impacting functionality related to sidelink communications. Moreover, with the allocation of multiple sidelink resources, the UE may retransmit failed sidelink communications without interfering with the network entity operating in a sleep mode.

As indicated above, FIG. 7 is provided as an example. Other examples may differ from what is described with respect to FIG. 7.

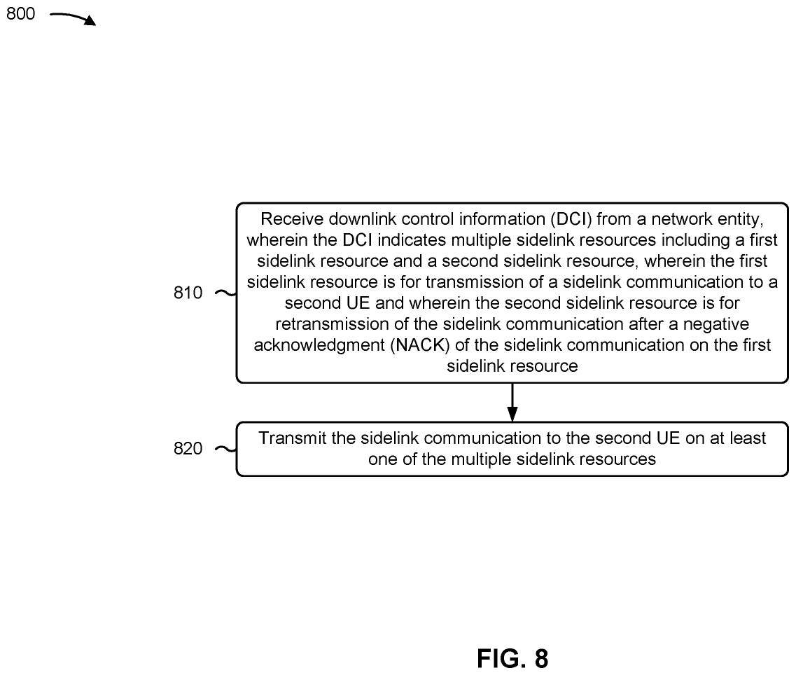

FIG. 8 shows a method 800 for wireless communications by a first UE, such as UE 120.

Method 800 begins at 810 with receiving DCI from a network entity. The DCI indicates multiple sidelink resources including a first sidelink resource and a second sidelink resource. The first sidelink resource is for transmission of a sidelink communication to a second UE, and the second sidelink resource is for retransmission of the sidelink communication after a NACK of the sidelink communication on the first sidelink resource.

Method 800 then proceeds to step 820 with transmitting the sidelink communication to the second UE on at least one of the multiple sidelink resources.

In one aspect, transmitting the sidelink communication to the second UE includes transmitting the sidelink communication to the second UE on the first sidelink resource and retransmitting the sidelink communication on the second sidelink resource as a result of at least one of receiving the NACK from the second UE and without receiving a subsequent DCI from the network entity .

In one aspect, method 800 further includes receiving the NACK from the second UE after transmitting the sidelink communication to the second UE on the first sidelink resource.

In one aspect, the method 800 further includes transmitting the NACK to the network entity.

In one aspect, the second sidelink resource occurs a predetermined number of slots after the first sidelink resource.

In a one aspect, the predetermined number of slots is based at least in part on a number of retransmission attempts.

In one aspect, the predetermined number of slots is indicated by a radio resource control configured parameter.

In one aspect, method 800 further includes receiving an indication of a number of retransmission attempts permitted on the multiple sidelink resources.

In one aspect, the number of retransmission attempts is a radio resource control configured parameter.

In one aspect, another of the multiple sidelink resources is allocated according to the DCI and a radio resource control configured offset.

In one aspect, at least one of a time characteristic or a frequency characteristic of the second sidelink resource is different from at least one of a time characteristic or a frequency characteristic of the first sidelink resource.

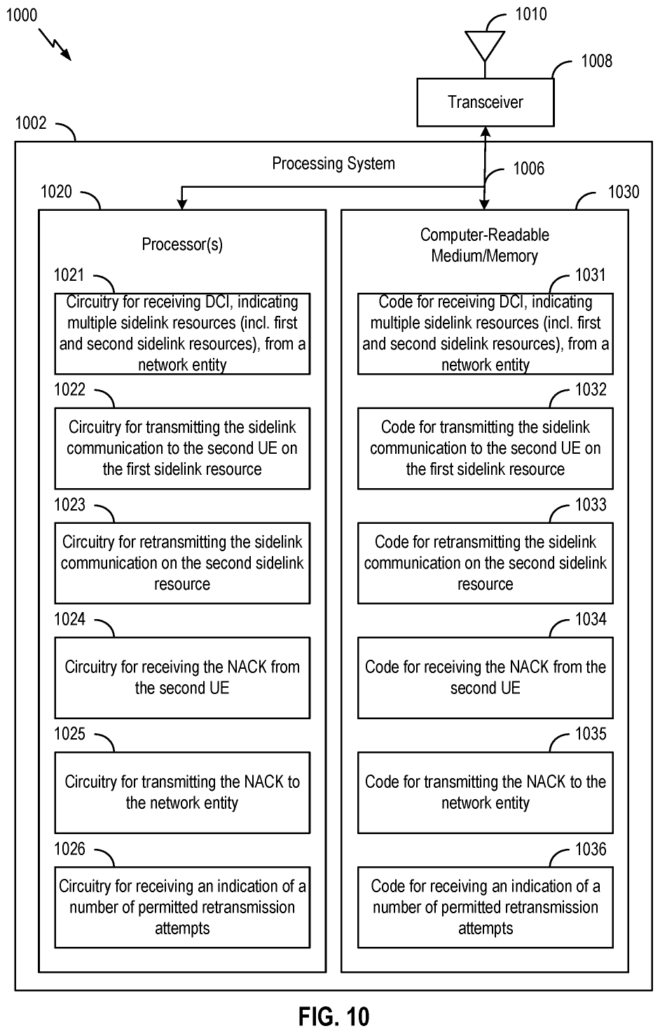

In one aspect, method 800, or any aspect related to it, may be performed by an apparatus, such as communications device 1000 of FIG. 10, which includes various components operable, configured, or adapted to perform the method 800. Communications device 1000 is described below in further detail.

Note that FIG. 8 is just one example of a method, and other methods including fewer, additional, or alternative steps are possible consistent with this disclosure.

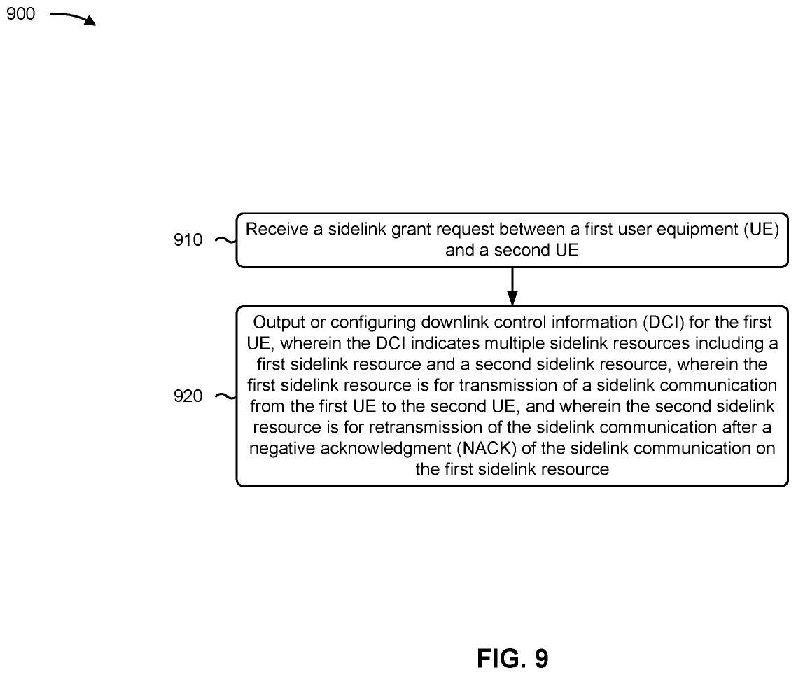

FIG. 9 shows a method 900 for wireless communications by a network entity, such as BS 110, or a disaggregated base station as discussed with respect to FIG. 3.

Method 900 begins at 910 with receiving a sidelink grant request between a first UE and a second UE.

Method 900 then proceeds to step 920 with outputting or configuring DCI for the first UE. The DCI indicates multiple sidelink resources including a first sidelink resource and a second sidelink resource. The first sidelink resource is for transmission of a sidelink communication from the first UE to the second UE. The second sidelink resource is for retransmission of the sidelink communication after a NACK of the sidelink communication on the first sidelink resource.

In one aspect, method 900 includes receiving the NACK from the first UE.

In one aspect, method 900 includes configuring the DCI to allocate the second sidelink resource a predetermined number of slots after the first sidelink resource.

In one aspect, the predetermined number of slots is based at least in part on a number of retransmission attempts.

In one aspect, method 900 includes configuring a radio resource control parameter with the predetermined number of slots.

In one aspect, method 900 includes outputting or configuring an indication of a number of retransmission attempts permitted on the multiple sidelink resources.

In one aspect, outputting or configuring the indication the number of the number of retransmission attempts comprises outputting or configuring radio resource control signaling indicating the number of retransmission attempts.

In one aspect, another of the multiple sidelink resources is allocated according to the DCI and a radio resource control configured offset.

In one aspect, at least one of a time characteristic or a frequency characteristic of the second sidelink resource is different from at least one of a time characteristic or a frequency characteristic of the first sidelink resource.

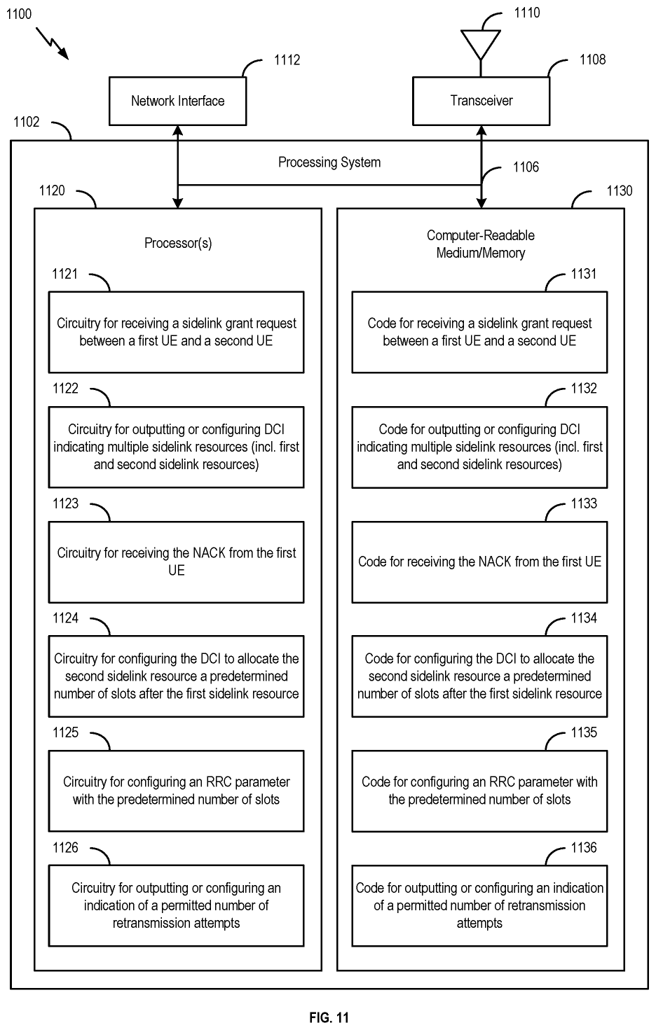

In one aspect, method 900, or any aspect related to it, may be performed by an apparatus, such as communications device 1100 of FIG. 11, which includes various components operable, configured, or adapted to perform the method 900. Communications device 1100 is described below in further detail.

Note that FIG. 9 is just one example of a method, and other methods including fewer, additional, or alternative steps are possible consistent with this disclosure.

FIG. 10 depicts aspects of an example communications device 1000. In some aspects, communications device 1000 is a user equipment, such as UE 120.

The communications device 1000 includes a processing system 1002 coupled to a transceiver 1008 (e.g., a transmitter and/or a receiver). The transceiver 1008 is configured to transmit and receive signals for the communications device 1000 via an antenna 1010, such as the various signals as described herein. The processing system 1002 may be configured to perform processing functions for the communications device 1000, including processing signals received and/or to be transmitted by the communications device 1000.

The processing system 1002 includes one or more processors 1020. In various aspects, the one or more processors 1020 may be representative of one or more of receive processor 258, transmit processor 264, TX MIMO processor 266, and/or controller/processor 280, as described with respect to FIG. 2. The one or more processors 1020 are coupled to a computer-readable medium/memory 1030 via a bus 1006. In certain aspects, the computer-readable medium/memory 1030 is configured to store instructions (e.g., computer-executable code) that when executed by the one or more processors 1020, cause the one or more processors 1020 to perform the method 800 described with respect to FIG. 8, or any aspect related to it. Note that reference to a processor performing a function of communications device 1000 may include one or more processors performing that function of communications device 1000.

In the depicted example, computer-readable medium/memory 1030 stores code (e.g., executable instructions) 1031 for receiving DCI, indicating multiple sidelink resources (including first sidelink resources and second sidelink resources), from a network entity, code 1032 for transmitting the sidelink communication to the second UE on the first sidelink resource, code 1033 for retransmitting the sidelink communication on the second sidelink resource, code 1034 for receiving the NACK from the second UE, code 1035 for transmitting the NACK to the network entity, and code 1036 for receiving an indication of a number of permitted retransmission attempts. Processing of the code 1031-1036 may cause the communications device 1000 to perform the method 800 described with respect to FIG. 8, or any aspect related to it.

The one or more processors 1020 include circuitry configured to implement (e.g., execute) the code stored in the computer-readable medium/memory 1030, including circuitry 1021 for receiving DCI, indicating multiple sidelink resources (including first sidelink resources and second sidelink resource), from a network entity, circuitry 1022 for transmitting the sidelink communication to the second UE on the first sidelink resource, circuitry 1023 for retransmitting the sidelink communication on the second sidelink resource, circuitry 1024 for receiving the NACK from the second UE, circuitry 1025 for transmitting the NACK to the network entity, and circuitry 1026 for receiving an indication of a number of permitted retransmission attempts. Processing with circuitry 1021-1026 may cause the communications device 1000 to perform the method 800 described with respect to FIG. 8, or any aspect related to it.

Various components of the communications device 1000 may provide means for performing the method 800 described with respect to FIG. 8, or any aspect related to it. For example, means for transmitting, sending, or outputting for transmission may include the transceivers 254 and/or antenna(s) 252 of the UE 120 and/or transceiver 1008 and antenna 1010 of the communications device 1000 in FIG. 10. Means for receiving or obtaining may include the transceivers 254 and/or antenna(s) 252 of the UE 120 and/or transceiver 1008 and antenna 1010 of the communications device 1000 in FIG. 10.

FIG. 11 depicts aspects of an example communications device. In some aspects, communications device 1100 is a network entity, such as BS 110, or a disaggregated base station as discussed with respect to FIG. 3.

The communications device 1100 includes a processing system 1102 coupled to a transceiver 1108 (e.g., a transmitter and/or a receiver) and/or a network interface 1112. The transceiver 1108 is configured to transmit and receive signals for the communications device 1100 via an antenna 1110, such as the various signals as described herein. The network interface 1112 is configured to obtain and send signals for the communications device 1100 via communications link(s), such as a backhaul link, midhaul link, and/or fronthaul link as described herein, such as with respect to FIG. 3. The processing system 1102 may be configured to perform processing functions for the communications device 1100, including processing signals received and/or to be transmitted by the communications device 1100.

The processing system 1102 includes one or more processors 1120. In various aspects, one or more processors 1120 may be representative of one or more of receive processor 238, transmit processor 220, TX MIMO processor 230, and/or controller/processor 240, as described with respect to FIG. 2. The one or more processors 1120 are coupled to a computer-readable medium/memory 1130 via a bus 1106. In certain aspects, the computer-readable medium/memory 1130 is configured to store instructions (e.g., computer-executable code) that when executed by the one or more processors 1120, cause the one or more processors 1120 to perform the method 900 described with respect to FIG. 9, or any aspect related to it. Note that reference to a processor of communications device 1100 performing a function may include one or more processors of communications device 1100 performing that function.

In the depicted example, the computer-readable medium/memory 1130 stores code 1131 (e.g., executable instructions) for receiving a sidelink grant request between a first UE and a second UE, code 1132 for outputting or configuring DCI indicating multiple sidelink resources (including a first sidelink resource and a second sidelink resource), code 1133 for receiving the NACK from the first UE, code 1134 for configuring the DCI to allocate the second sidelink resource a predetermined number of slots after the first sidelink resource, code 1135 for configuring an RRC parameter with the predetermined number of slots, and code 1136 for outputting or configuring an indication of a permitted number of retransmission attempts. Processing of the code 1131-1136 may cause the communications device 1100 to perform the method 900 described with respect to FIG. 9, or any aspect related to it.

The one or more processors 1120 include circuitry configured to implement (e.g., execute) the code stored in the computer-readable medium/memory 1130, including circuitry 1121 for receiving a sidelink grant request between a first UE and a second UE, circuitry 1122 for outputting or configuring DCI indicating multiple sidelink resources (including a first sidelink resource and a second sidelink resource), circuitry 1123 for receiving the NACK from the first UE, circuitry 1124 for configuring the DCI to allocate the second sidelink resource a predetermined number of slots after the first sidelink resource, circuitry 1125 for configuring an RRC parameter with the predetermined number of slots, and circuitry 1126 for outputting or configuring an indication of a permitted number of retransmission attempts. Processing with circuitry 1121-1126 may cause the communications device 1100 to perform the method 900 as described with respect to FIG. 9, or any aspect related to it.

Various components of the communications device 1100 may provide means for performing the method 900 as described with respect to FIG. 9, or any aspect related to it. Means for transmitting, sending, or outputting for transmission may include the transceivers 232 and/or antenna(s) 234 of the BS 110 and/or transceiver 1108 and antenna 1110 of the communications device 1100 in FIG. 11. Means for receiving or obtaining may include the transceivers 232 and/or antenna(s) 234 of the BS 110 and/or transceiver 1108 and antenna 1110 of the communications device 1100 in FIG. 11.

The following provides an overview of some Aspects of the present disclosure:

Aspect 1: A method of wireless communication performed by a first UE, comprising: receiving DCI from a network entity, wherein the DCI indicates multiple sidelink resources including a first sidelink resource and a second sidelink resource, wherein the first sidelink resource is for transmission of a sidelink communication to a second UE and wherein the second sidelink resource is for retransmission of the sidelink communication after a NACK of the sidelink communication on the first sidelink resource; and transmitting the sidelink communication to the second UE on at least one of the multiple sidelink resources.

Aspect 2: The method of Aspect 1, wherein transmitting the sidelink communication to the second UE includes transmitting the sidelink communication to the second UE on the first sidelink resource and retransmitting the sidelink communication on the second sidelink resource as a result of at least one of receiving the NACK from the second UE and without receiving a subsequent DCI from the network entity.

Aspect 3: The method of any of Aspects 1-2, further comprising receiving the NACK from the second UE after transmitting the sidelink communication to the second UE on the first sidelink resource.

Aspect 4: The method of Aspect 3, further comprising transmitting the NACK to the network entity.

Aspect 5: The method of any of Aspects 1-4, wherein the second sidelink resource occurs a predetermined number of slots after the first sidelink resource.

Aspect 6: The method of Aspect 5, wherein the predetermined number of slots is based at least in part on a number of retransmission attempts.

Aspect 7: The method of Aspect 5, wherein the predetermined number of slots is indicated by a radio resource control configured parameter.

Aspect 8: The method of any of Aspects 1-7, further comprising receiving an indication of a number of retransmission attempts permitted on the multiple sidelink resources.

Aspect 9: The method of Aspect 8, wherein the number of retransmission attempts is a radio resource control configured parameter.

Aspect 10: The method of any of Aspects 1-9, wherein another of the multiple sidelink resources is allocated according to the DCI and a radio resource control configured offset.

Aspect 11: The method of any of Aspects 1-10, wherein at least one of a time characteristic or a frequency characteristic of the second sidelink resource is different from at least one of a time characteristic or a frequency characteristic of the first sidelink resource.

Aspect 12: A method of wireless communication performed by a network entity, comprising: receiving a sidelink grant request between a first user equipment (UE) and a second UE; and outputting or configuring downlink control information (DCI) for the first UE, wherein the DCI indicates multiple sidelink resources including a first sidelink resource and a second sidelink resource, wherein the first sidelink resource is for transmission of a sidelink communication from the first UE to the second UE, and wherein the second sidelink resource is for retransmission of the sidelink communication after a negative acknowledgment (NACK) of the sidelink communication on the first sidelink resource.

Aspect 13: The method of Aspect 12, further comprising receiving the NACK from the first UE.

Aspect 14: The method of any of Aspects 12-13, further comprising configuring the DCI to allocate the second sidelink resource a predetermined number of slots after the first sidelink resource.

Aspect 15: The method of Aspect 14, wherein the predetermined number of slots is based at least in part on a number of retransmission attempts.

Aspect 16: The method of Aspect 14, further comprising configuring a radio resource control parameter with the predetermined number of slots.

Aspect 17: The method of any of Aspects 12-16, further comprising outputting or configuring an indication of a number of retransmission attempts permitted on the multiple sidelink resources.

Aspect 18: The method of Aspect 17, wherein outputting or configuring the indication the number of the number of retransmission attempts comprises outputting or configuring radio resource control signaling indicating the number of retransmission attempts.

Aspect 19: The method of any of Aspects 12-18, wherein another of the multiple sidelink resources is allocated according to the DCI and a radio resource control configured offset.

Aspect 20: The method of any of Aspects 12-19, wherein at least one of a time characteristic or a frequency characteristic of the second sidelink resource is different from at least one of a time characteristic or a frequency characteristic of the first sidelink resource.

Aspect 21: An apparatus for wireless communication at a device, comprising a processor; memory coupled with the processor; and instructions stored in the memory and executable by the processor to cause the apparatus to perform the method of one or more of Aspects 1-20.

Aspect 22: A device for wireless communication, comprising a memory and one or more processors coupled to the memory, the one or more processors configured to perform the method of one or more of Aspects 1-20.

Aspect 23: An apparatus for wireless communication, comprising at least one means for performing the method of one or more of Aspects 1-20.

Aspect 24: A non-transitory computer-readable medium storing code for wireless communication, the code comprising instructions executable by a processor to perform the method of one or more of Aspects 1-20.

Aspect 25: A non-transitory computer-readable medium storing a set of instructions for wireless communication, the set of instructions comprising one or more instructions that, when executed by one or more processors of a device, cause the device to perform the method of one or more of Aspects 1-20.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules, and circuits described in connection with the present disclosure may be implemented or performed with a general purpose processor, a digital signal processor (DSP), an application-specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices (e.g., a combination of a DSP and a microprocessor, a plurality of microprocessors, one or more microprocessors in conjunction with a DSP core, a system on a chip (SoC), or any other such configuration).

As used herein, the term “determining” encompasses a wide variety of actions. For example, “determining” may include calculating, computing, processing, deriving, investigating, looking up (e.g., looking up in a table, a database, or another data structure), ascertaining, and the like. Also, “determining” may include receiving (e.g., receiving information), accessing (e.g., accessing data in a memory), and the like. Also, “determining” may include resolving, selecting, choosing, establishing, and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method of wireless communication performed by a first user equipment (UE), comprising:
receiving downlink control information (DCI) from a network entity, wherein the DCI indicates multiple sidelink resources including a first sidelink resource and a second sidelink resource, wherein the first sidelink resource is for transmission of a sidelink communication to a second UE and wherein the second sidelink resource is for retransmission of the sidelink communication after a negative acknowledgment (NACK) of the sidelink communication on the first sidelink resource; and
transmitting the sidelink communication to the second UE on at least one of the multiple sidelink resources.

2. The method of claim 1, wherein transmitting the sidelink communication to the second UE includes transmitting the sidelink communication to the second UE on the first sidelink resource and retransmitting the sidelink communication on the second sidelink resource as a result of at least one of receiving the NACK from the second UE and without receiving a subsequent DCI from the network entity.

3. The method of claim 1, further comprising receiving the NACK from the second UE after transmitting the sidelink communication to the second UE on the first sidelink resource.

4. The method of claim 3, further comprising transmitting the NACK to the network entity.

5. The method of claim 1, wherein the second sidelink resource occurs a predetermined number of slots after the first sidelink resource.

6. The method of claim 5, wherein the predetermined number of slots is based at least in part on a number of retransmission attempts.

7. The method of claim 5, wherein the predetermined number of slots is indicated by a radio resource control configured parameter.

8. The method of claim 1, further comprising receiving an indication of a number of retransmission attempts permitted on the multiple sidelink resources.

9. The method of claim 8, wherein the number of retransmission attempts is a radio resource control configured parameter.

10. The method of claim 1, wherein another of the multiple sidelink resources is allocated according to the DCI and a radio resource control configured offset.

11. The method of claim 1, wherein at least one of a time characteristic or a frequency characteristic of the second sidelink resource is different from at least one of a time characteristic or a frequency characteristic of the first sidelink resource.

12. A method of wireless communication performed by a network entity, comprising:
receiving a sidelink grant request between a first user equipment (UE) and a second UE; and
outputting or configuring downlink control information (DCI) for the first UE, wherein the DCI indicates multiple sidelink resources including a first sidelink resource and a second sidelink resource, wherein the first sidelink resource is for transmission of a sidelink communication from the first UE to the second UE, and wherein the second sidelink resource is for retransmission of the sidelink communication after a negative acknowledgment (NACK) of the sidelink communication on the first sidelink resource.

13. The method of claim 12, further comprising receiving the NACK from the first UE.

14. The method of claim 12, further comprising configuring the DCI to allocate the second sidelink resource a predetermined number of slots after the first sidelink resource.

15. The method of claim 14, wherein the predetermined number of slots is based at least in part on a number of retransmission attempts.

16. The method of claim 14, further comprising configuring a radio resource control parameter with the predetermined number of slots.

17. The method of claim 12, further comprising outputting or configuring an indication of a number of retransmission attempts permitted on the multiple sidelink resources.

18. The method of claim 17, wherein outputting or configuring the indication the number of the number of retransmission attempts comprises outputting or configuring radio resource control signaling indicating the number of retransmission attempts.

19. The method of claim 12, wherein another of the multiple sidelink resources is allocated according to the DCI and a radio resource control configured offset.

20. The method of claim 12, wherein at least one of a time characteristic or a frequency characteristic of the second sidelink resource is different from at least one of a time characteristic or a frequency characteristic of the first sidelink resource.

21. A user equipment (UE) configured for wireless communications, comprising: a memory comprising processor-executable instructions; and a processor configured to execute the processor-executable instructions and cause the user equipment to:
receive downlink control information (DCI) from a network entity, wherein the DCI indicates multiple sidelink resources including a first sidelink resource and a second sidelink resource, wherein the first sidelink resource is for transmission of a sidelink communication to a second UE and wherein the second sidelink resource is for retransmission of the sidelink communication after a negative acknowledgment (NACK) of the sidelink communication on the first sidelink resource; and
transmit the sidelink communication to the second UE on at least one of the multiple sidelink resources.

22. A network entity configured for wireless communications, comprising: a memory comprising processor-executable instructions; and a processor configured to execute the processor-executable instructions and cause the network entity to:
receive a sidelink grant request between a first user equipment (UE) and a second UE; and
output or configure downlink control information (DCI) for the first UE, wherein the DCI indicates multiple sidelink resources including a first sidelink resource and a second sidelink resource, wherein the first sidelink resource is for transmission of a sidelink communication from the first UE to the second UE, and wherein the second sidelink resource is for retransmission of the sidelink communication after a negative acknowledgment (NACK) of the sidelink communication on the first sidelink resource.
